(19) United States
(12) Patent Application Publication
(10) Pub. No.: US 2020/0097570 A1
(43) Pub. Date: Mar. 26, 2020

(54) VISUAL SEARCH ENGINE

(71) Applicant: salesforce.com, Inc., San Francisco, CA (US)

(72) Inventor: Michael Sollami, San Francisco, CA (US)

(21) Appl. No.: 16/168,182

(22) Filed: Oct. 23, 2018

Related U.S. Application Data
(60) Provisional application No. 62/735,604, filed on Sep. 24, 2018.

(51) Int. Cl. G06F 17/30; G06N 3/08

(52) U.S. Cl. CPC G06F 17/30277; G06F 17/30867; G06N 3/08; G06F 17/30554; G06F 17/30271

(57) ABSTRACT

A method of visual search of a data set includes receiving a request from a client digital data device comprising an image and utilizing a detection model to identify, in the image, apparent objects of interest, as well as bounding boxes within the image of those apparent objects. For each of one of more of the apparent objects of interest, the method extracts a sub-image defined by its respective bounding box. A feature retrieval model is used to identify features of apparent objects in each of those sub-images, and those features are applied (e.g., as text or otherwise) to a search engine to identify items in the digital data set. Results of the search can be presented on a digital data device of a requesting user.

This application claims the benefit of filing of U.S. Patent Application Ser. No. 62/735,604, filed Sep. 24, 2018, the teachings of which are incorporated herein by reference.

### BACKGROUND

This pertains to automatically generated digital content and, more particularly, to digital content generated through image-based searching of data sets. It has use, by way of non-limiting example, in the searching of e-commerce and other sites.

Words sometimes fail us. That can be a problem when it comes to buying on the internet. If you cannot describe it, how can you find it—much less, acquire it? The problem is not limited to e-commerce, of course. Most searches, whether for government, research or other sites, begin with words.

The art is making in-roads into solving the problem. Image-based searching, also known as Content Based Image Retrieval (CBIR), has recently come to the fore. There remains much room for improvement, however, specifically on the problem of real-time and fine-grained retrieval of consumer products, where the many levels of variability in the query image makes this difficult.

### BRIEF DESCRIPTION OF THE DRAWINGS

A more complete understanding of the discussion that follows may be attained by reference to the drawings, in which:

FIG. 1 depicts an environment in which an embodiment is employed;

FIG. 2 depicts an embodiment for visual searching.

### DETAILED DESCRIPTION OF THE ILLUSTRATED EMBODIMENT

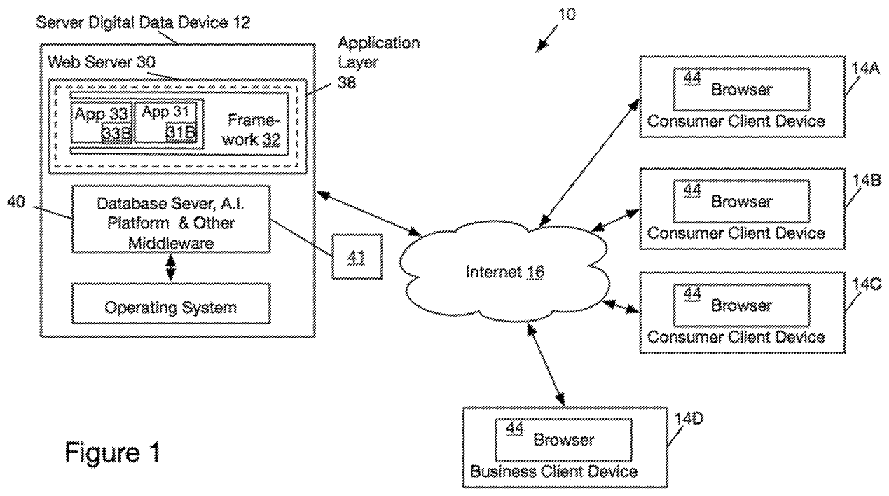

FIG. 1 depicts a digital data processing system 10 that includes a server digital data device (“server”) 12 coupled to client digital data devices (“clients”) 14A-14D via a network 16. By way of non-limiting example, illustrated server 12 hosts an e-commerce portal or platform (collectively, “platform”) of an online retailer, and clients 14A-14D are digital devices (e.g., smart phones, desktop computers, and so forth) of customers of that retailer, administrators and other users (collectively, “users”) of that platform.

Devices 12, 14A-14D comprise conventional desktop computers, workstations, minicomputers, laptop computers, tablet computers, PDAs, mobile phones or other digital data devices of the type that are commercially available in the marketplace, all as adapted in accord with the teachings hereof. Thus, each comprises central processing, memory, and input/output subsections (not shown here) of the type known in the art and suitable for (i) executing software of the type described herein and/or known in the art (e.g., applications software, operating systems, and/or middleware, as applicable) as adapted in accord with the teachings hereof and (ii) communicating over network 16 to other devices 12, 14A-14D in the conventional manner known in the art as adapted in accord with the teachings hereof.

Examples of such software include web server 30 that executes on device 12 and that responds to requests in HTTP or other protocols from clients 14A-14D (at the behest of users thereof) for transferring web pages, downloads and other digital content to the requesting device over network 16 in the conventional manner known in the art as adapted in accord with the teachings hereof. Web server 30 includes web applications 31, 33 that include respective search front-ends 31B, 33B, both of which may be part of broader functionality provided by the respective web applications 31, 33 such as, for example, serving up websites or web services (collectively, “websites”) to client devices 14A-14D, all per convention in the art as adapted in accord with the teachings hereof.

Such a web site, accessed by way of example by client devices 14A-14C and hosted by way of further example by web application 31, is an e-commerce site of a retailer, e.g., for advertising and selling goods from an online catalog to its customers, per convention in the art as adapted in accord with the teachings hereof.

Another such web site, accessed by way of example by client device 14D and hosted by way of further example by web application 33, is a developer or administrator portal (also referred to here as “administrator site” or the like) for use by employees, consultants or other agents of the aforesaid retailer in maintaining the aforesaid e-commerce site and, more particularly, by way of non-limiting example, training the search engine of the e-commerce site to facilitate searching of the aforesaid catalog.

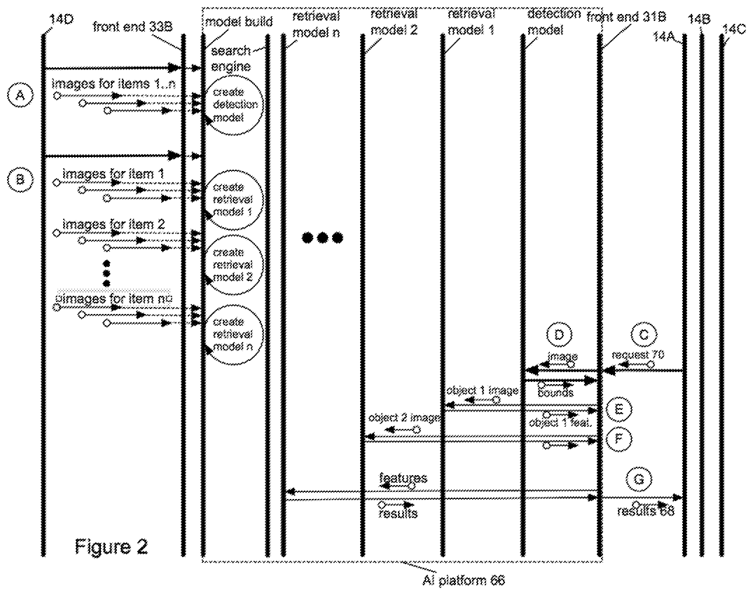

Search front-ends 31B, 33B are server-side front-ends of an artificial intelligence-based platform 66 (FIG. 2) that includes a search engine of the type that (i) responds to a search request, received via front-end 31B, e.g., at the behest of a user of a client device 14A-14C, to search a data set 41 containing or otherwise representing a catalog of items available through web application 31, (ii) through front-end 31B, transmits a listing of items from that catalog matching the search to the requesting client device 14A-14C for presentation to the user thereof via the respective browser 44, e.g., as part of web pages, downloads and other digital content per convention in the art as adapted in accord with the teachings hereof, and (iii) through front-end 33B facilitates training of models used in support of those searches per convention in the art as adapted in accord with the teachings hereof. In an embodiment, such as that illustrated here, where server 12 hosts e-commerce websites and, more particularly, where web applications 31, 33 serve an e-commerce site and an administrator site therefor, the searched-for items can be for goods or services (collectively, “goods” or “products”) of the retailer, though, other embodiments may vary in this regard.

Data set 41 comprises a conventional data set of the type known in the art for use in storing and/or otherwise representing items in an e-commerce or other online catalog or data set. That data set 41 can be directly coupled to server 12 or otherwise accessible thereto, all per convention in the art as adapted in accord with the teachings hereof.

The aforesaid search engine of the illustrated embodiment is of the conventional type known in the art (as adapted in accord with the teachings hereof) that utilizes artificial intelligence model-based image recognition to support searching based on search requests that include images as well, in some embodiments, as text. Such models can be based in neural networks, or otherwise, as per convention in the art as adapted in accord with the teachings hereof.

Web framework 32 comprises conventional such software known in the art (as adapted in accord with the teachings hereof) providing libraries and other reusable services that are (or can be) employed—e.g., via an applications program interface (API) or otherwise—by multiple and/or a variety of web applications executing on the platform supported by server 12, two of which applications are shown here (to wit, web applications 31, 33).

In the illustrated embodiment, web server 30 and its constituent components, web applications 31, 33 and framework 32, execute within an application layer 38 of the server architecture. That layer 38, which provides services and supports communications protocols in the conventional manner known in the art as adapted in accord with the teachings hereof, can be distinct from other layers in the server architecture—layers that provide services and, more generally, resources (a/k/a “server resources”) that are required by the web applications 31, 33 and/or framework 32 in order to process at least some of the requests received by server 30 from clients 14A-14D, and so forth, all per convention in the art as adapted in accord with the teachings hereof.

Those other layers include, for example, a data layer 40—which provides middleware, including the artificial intelligence platform 66 (FIG. 2) and which supports interaction with a database server 40, all in the conventional manner known in the art as adapted in accord with the teachings hereof and all by way of non-limiting example—and the server's operating system 42, which manages the server hardware and software resources and provides common services for software executing thereon in the conventional manner known in the art as adapted in accord with the teachings hereof.

Other embodiments may utilize an architecture with a greater or lesser number of layers and/or with layers providing different respective functionalities than those illustrated here.

Though described here in the context of retail and corresponding administrative websites, in other embodiments web server 30 and applications 31, 33 and framework 32 may define web services or other functionality (e.g., available through an API or otherwise) suitable for responding to user requests, e.g., a video server, a music server, or otherwise. And, though shown and discussed here as comprising separate web applications 31, 33 and framework 32, in other embodiments, the web server 30 may combine the functionalities of those components or distribute them among still more components.

Moreover, although the retail and administrative websites are shown, here, as hosted by different respective web applications 31, 33, in other embodiments those websites may be hosted by a single such application or, conversely, by more than two such applications. And, by way of further example, although web applications 31, 33 are shown in the drawing as residing on a single common platform 12 in the illustrated embodiment, in other embodiments they may reside on different respective platforms and/or their functionality may be divided among two or more platforms. Likewise, although artificial intelligence platform 66 is described here as forming part of the middleware of a single platform 12, it other embodiments the functionality ascribed to element 66 may be distributed over multiple platforms or other devices.

With continued reference to FIG. 1, client devices 14A-14D of the illustrated embodiment execute web browsers 44 that (typically) operate under user control to generate requests in HTTP or other protocols, e.g., to access websites on the aforementioned platform, to search for goods available on, through or in connection with that platform (e.g., goods available from a web site retailer—whether online and/or through its brick-and-mortar outlets), to advance-order or request the purchase (or other acquisition) of those goods, and so forth, and to transmit those requests to web server 30 over network 14—all in the conventional manner known in the art as adapted in accord with the teachings hereof. Though referred to here as web browsers, in other embodiments applications 44 may comprise web apps or other functionality suitable for transmitting requests to a server 30 and/or presenting content received therefrom in response to those requests, e.g., a video player application, a music player application or otherwise.

The devices 12, 14A-14D of the illustrated embodiment may be of the same type, though, more typically, they constitute a mix of devices of differing types. And, although only a single server digital data device 12 is depicted and described here, it will be appreciated that other embodiments may utilize a greater number of these devices, homogeneous, heterogeneous or otherwise, networked or otherwise, to perform the functions ascribed hereto to web server 30 and/or digital data processor 12. Likewise, although four client devices 14A-14D are shown, it will be appreciated that other embodiments may utilize a greater or lesser number of those devices, homogeneous, heterogeneous or otherwise, running applications (e.g., 44) that are, themselves, as noted above, homogeneous, heterogeneous or otherwise. Moreover, one or more of devices 12, 14A-14D may be configured as and/or to provide a database system (including, for example, a multi-tenant database system) or other system or environment; and, although shown here in a client-server architecture, the devices 12, 14A-14D may be arranged to interrelate in a peer-to-peer, client-server or other protocol consistent with the teachings hereof.

Network 16 is a distributed network comprising one or more networks suitable for supporting communications between server 12 and client device 14A-14D. The network comprises one or more arrangements of the type known in the art, e.g., local area networks (LANs), wide area networks (WANs), metropolitan area networks (MANs), and or Internet(s). Although a client-server architecture is shown in the drawing, the teachings hereof are applicable to digital data devices coupled for communications in other network architectures.

As those skilled in the art will appreciate, the “software” referred to herein—including, by way of non-limiting example, web server 30 and its constituent components, web applications 31, 33 and web application framework 32, browsers 44—comprise computer programs (i.e., sets of computer instructions) stored on transitory and non-transitory machine-readable media of the type known in the art as adapted in accord with the teachings hereof, which computer programs cause the respective digital data devices, e.g., 12, 14A-14D to perform the respective operations and functions attributed thereto herein. Such machine-readable media can include, by way of non-limiting example, hard drives, solid state drives, and so forth, coupled to the respective digital data devices 12, 14A-14D in the conventional manner known in the art as adapted in accord with the teachings hereof.

Described below in connection with FIG. 2 is operation of the web applications 31, 33 in connection with Al platform 66, as well as with other components of the illustrated system 10, to support image-based (a/k/a “visual”) searching of the catalog/data set 41 and more particularly, by way of example, to return search results 68 identifying items from that catalog matching a specified request. This can be in response to an image-based search request 70 generated by the web browser 44 of a client device, e.g., 14A and, more particularly, by way of non-limiting example, in response to a such a generated by a “search” widget or other code executing in a web page or other content downloaded by and presented on that browser 44, or otherwise, as per convention in the art as adapted in accord with the teachings hereof. In the drawing, operational steps are identified by circled letters, and data transfers are identified by arrows.

In step A, client device 14D transfers to the platform 66 via front end 33B (e.g., at the behest of an administrator or other) images of n items in the catalog, i.e., items that may be searched via image-based search requests emanating from client devices 14A-14C. Those images may be of the conventional type known in the art (as adapted in accord with the teachings hereof) suitable for use in training an image-based neural network or other Al model. Thus, the images can be of JPEG, PNG or other format (industry-standard or otherwise) and sized suitably to allow the respective items to be discerned and modeled. The images may be generated by device 14D or otherwise (e.g., via a digital camera, smart phone or otherwise), per convention in the art as adapted in accord with the teachings hereof. Along with each image, the client device 14D transfers a label or other identifier of the item to which the image pertains, again per convention in the art as adapted in accord with the teachings hereof.

Although device 14D may transfer a single image for each of the n catalog items, in most embodiments multiple images are provided for each such item, i.e., images showing the item from multiple perspectives, e.g., expected to match those in which the items may appear in image-based search requests (e.g., 70) from the client devices 14A-14C, all per convention in the art as adapted in accord with the teachings hereof. In addition to multiple views of each catalog item, in some embodiments, the client device 14D transfers images of each catalog item in a range of “qualities”—i.e., some showing a respective catalog item unobstructed with no background, and some showing that item with obstructions and/or background. In such embodiments, for each item, images showing it sans obstruction and background are transferred by client device 14D to front end 33B for use by platform 66, first, for training, followed by those images showing that catalog item with obstructions and/or background to be used by platform 66, subsequently, for such training.

As part of illustrated step A, a model-build component of the Al platform 66 receives the images from front end 33B and creates a neural network-based or other Al model suitable for detecting the occurrence of one or more of the items in an image. This is referred to below and in the drawing as a “detection model.” The model-build component can be implemented and operated in the conventional manner known in the art as adapted in accord with teachings hereof to generate that model, and the model itself is of the conventional type known in the art for facilitating detection of an item in an image (e.g., regardless of its specific feature—as discussed below) as adapted in accord with the teachings hereof.

In step B, the model-build component of the Al platform 66 generates individual models for each of the n catalog items. Unlike the detection model, the models generated in step B are feature models, intended to identify specific features of an item in an image. Examples of such features, e.g., for a shirt, might include color, sleeve or sleeveless, collar or no collar, buttons or no buttons, and so forth. The model-build component can be implemented and operated in the conventional manner known in the art as adapted in accord with teachings hereof to generate such models, which themselves may be of the conventional type known in the art for facilitating identifying features of an item in an image, as adapted in accord with the teachings hereof.

In step C, a client device, e.g., 14A, of a customer of the e-commerce web site transmits an image-based request 70, as described above, to the front end 31B of the platform 66. This can be accomplished in a conventional manner known in the art as adapted in accord with the teachings hereof.

In step D, the front end 31B, in turn, transmits the image from that request to the detection model, which utilizes the training from step A to identify apparent catalog items (also, referred to as “apparent objects of interest” elsewhere herein) in the image, along with bounding boxes where the apparent object resides in the image and a measure of certainty of the match between the actual catalog object (from which the model was trained in step A) and the possible match in the image received in step C. Operation of the Al platform 66 and, more particularly, the detection model for such purposes is within the ken of those skilled in the art in view of the teachings hereof.

In steps E-F, the front end 31B extracts each individual apparent catalog object in the image received in step C utilizing the corresponding bounding boxes provided in step D, and provides that extracted image (or “sub-image”) to the respective feature retrieval model which, in turn, returns to the front end 31B a listing of features of the object shown in the extracted image. Extraction of images of apparent catalog objects as described above is within the ken of those skilled in the art in view of the teachings hereof. Likewise, implementation and operation of the Al platform 66 and, more particularly, the feature models for purposes of identifying features of apparent catalog objects shown in the extracted images is within the ken of those skilled in the art in view of the teachings hereof.

By way of example, in step E, the front end 31B isolates an image of a first apparent catalog object (say, an apparent mens Hawaiian shirt, for example) from the image provided in C and sends that extracted sub-image to the feature retrieval model for Hawaiian shirts. Using that feature retrieval model, the platform 66 returns a list of features for the shirt shown in the sub-image, e.g., color, sleeved, collared, and so forth. The listing can be expressed in text, as a vector or otherwise, all per convention in the art as adapted in accord with the teachings hereof.

Likewise, in step F, the front end 31B isolates an image of a soft-sided leather briefcase, for example, from the image provided in C and sends the respective sub-image to the feature retrieval model for such briefcases. Using that feature retrieval model, the platform 66 returns a list of features for the briefcase shown in the extracted image, e.g., color, straps, buckles, and so forth. Again, the listing can be expressed in text, as a vector or otherwise, all per convention in the art as adapted in accord with the teachings hereof.

Though, steps E-F show use of feature retrieval models for two objects extracted from the image provided in step C, in practice the front end 31B may execute those steps fewer or a greater number of times, depending on how many apparent objects were identified by the detection model in step D.

In step G, the front end 31B performs a search of the catalog dataset 41 using the features discerned by the feature retrieval model in steps E-F. This can be a text-based search or otherwise (e.g., depending on the format of the features returned to the front end 31B in steps E-F or otherwise) and can be performed by a search engine that forms part of the Al platform or otherwise. That engine returns catalog items matching the search, exactly, loosely or otherwise, per convention in the art as adapted in accord with the teachings hereof, which results are transmitted to the requesting client digital data device for presentation thereon to a user thereof. Operation of the search engine and return of such results pursuant to the above is within the ken of those skilled in the art as adapted in accord with the teachings hereof.

Steps C-G are similarly repeated in connection with further image-based search requests by client devices 14A-14C at the behest of users thereof.

Described above and shown in the drawings are apparatus, systems, and method for image-based searching. It will be appreciated that the embodiments shown here are merely examples and that others fall within the scope of the claims set forth below. Thus, by way of example, although the discussion above focuses on e-commerce catalog searches, it will be appreciated that this applies equally to searches of other data sets.

In view of the foregoing, what is claimed is:

1. A digital data processing method of visual search of a data set comprising,
receiving a request from a client digital data device comprising an image,
identifying in the image apparent objects of interest and bounding boxes within the image therefore,
for each of one of more of the apparent objects of interest, extracting a sub-image defined by the respective bounding box identified in connection therewith,
identifying features of apparent objects in each of one or more sub-images,
applying the one or more of the identified features to a search engine to identify items in a digital data set,
presenting on the client digital data device one or more of the identified items from the digital data set.

2. The method of claim 1, comprising generating a measure of uncertainty in connection with identifying in the image apparent objects of interest.

3. The method of claim 1, comprising identifying the features any of by way of text, vectors or otherwise.

4. The method of claim 3, comprising applying any of text and vector identifying a feature to the search engine to identify items in the digital data set.

5. The method of claim 1, comprising using artificial intelligence to generate the detection model.

6. The method of claim 5, the detection model comprising a neural network.

7. The method of claim 6, comprising using images of each item in the data set to train the neural network.

8. The method of claim 7, comprising using multiple images of each item to train the neural network, where the multiple images show the item with and without obstruction and with and without background.

9. The method of claim 1, comprising using artificial intelligence to generate the feature retrieval models.

10. The method of claim 9, the feature retrieval models each comprising a neural network.

11. The method of claim 10, comprising using images of each item in the data set to train the neural network.

12. Computer instructions configured to cause one or more digital data devices to perform the steps of:
receiving a request from a client digital data device comprising an image,
identifying in the image apparent objects of interest and bounding boxes within the image therefore,
for each of one of more of the apparent objects of interest, extracting a sub-image defined by the respective bounding box identified in connection therewith,
identifying features of apparent objects in each of one or more sub-images,
applying the one or more of the identified features to a search engine to identify items in a digital data set,
presenting on the client digital data device one or more of the identified items from the digital data set.

13. The computer instructions of claim 12 configured to cause the one or more digital data devices to perform steps including generating a measure of uncertainty in connection with identifying in the image apparent objects of interest.

14. The computer instructions of claim 12 configured to cause the one or more digital data devices to perform steps including identifying the features any of by way of text, vectors or otherwise.

15. The computer instructions of claim 14 configured to cause the one or more digital data devices to perform steps including applying any of text and vector identifying a feature to the search engine to identify items in the digital data set.

16. The computer instructions of claim 12 configured to cause the one or more digital data devices to perform steps including using artificial intelligence to generate the detection model.

17. The computer instructions of claim 16 configured to cause the one or more digital data devices to perform steps including using images of each item in the data set to train a neural network.

18. The computer instructions of claim 17 configured to cause the one or more digital data devices to perform steps including using multiple images of each item to train the neural network, where the multiple images show the item with and without obstruction and with and without background.

19. The computer instructions of claim 12 configured to cause the one or more digital data devices to perform steps including using artificial intelligence to generate the feature retrieval models.

20. A machine-readable storage medium having stored thereon a computer program configured to cause one or more digital data devices to perform the steps of:
receiving a request from a client digital data device comprising an image,
identifying in the image apparent objects of interest and bounding boxes within the image therefore,
for each of one of more of the apparent objects of interest, extracting a sub-image defined by the respective bounding box identified in connection therewith,
identifying features of apparent objects in each of one or more sub-images,
applying the one or more of the identified features to a search engine to identify items in a digital data set,
presenting on the client digital data device one or more of the identified items from the digital data set.
